(19) United States
(12) Patent Application Publication
(10) Pub. No.: US 2016/0172653 A1
(43) Pub. Date: Jun. 16, 2016

(54) BATTERY CONTAINMENT

(71) Applicant: NEC Energy Solutions, Inc., Westborough, MA (US)

(72) Inventors: David H. Henderson, Shirley, MA (US); Eric M. Greenberg, Brighton, MA (US)

(21) Appl. No.: 14/570,045

(22) Filed: Dec. 15, 2014

(51) Int. Cl. H01M 2/22; H01M 10/42; H01M 10/04

(52) U.S. Cl. CPC H01M 2/22; H01M 10/0422; H01M 10/425; H01M 2010/4271

(57) ABSTRACT

A battery housing for lithium ion cells includes a plurality of cell modules, having a plurality of cells between a top conductive plate and a bottom conductive plate and attached to a conductive plate by tabs attached to similarly polarized ends of each of the cells in the module to define a parallel connection between all of the cells in the module. A battery housing stacks the modules to define a series connection between the charge plates, and electrically couples adjacent stacks with a common charge plate to define a series connection between each of the stacks. Charge logic for preventing excessive charging or discharging of the cells, and permits charge and discharge rates up to 6C. Tabs on each conductive plate provide a redundant connection to each circular face of the cells for resisting shock and vibration.

### BACKGROUND

For decades, portable electrical power supplies have taken the form of batteries that release electrical energy from an electrochemical reaction. Various battery chemistries, such as traditional “dry cell” carbon flashlight batteries, and lead acid “wet” cells common in automobiles have provided adequate portable electrical power for most uses. Modern electronics, however, place significantly greater demands on the longevity and mass of batteries. Battery power has traditionally come at a premium of the mass required for the charge material for generating sufficient current. Conventional flashlight batteries deliver only low current. Automobile batteries for delivering an intense but brief high amperage flow to a starter motor are very dense and large. Modern electronic devices, such as cell phones, computing devices, and automobiles, demand substantial current delivery while being lightweight and small enough to avoid hindering the portability of the host device.

Rechargeable nickel-cadmium (NiCad) and nickel metal hydride (NiMH) had gained popularity for rechargeable batteries for portable devices. Recently, however, advances in lithium-ion batteries (LIBs) have been significant such that that they have become the most popular power source for portable electronics equipment, and are also growing in popularity for military, electric vehicle, and aerospace applications. Continuing development of personnel electronics, hybrid and electric vehicles, and industrial power storage and support ensures that Li-ion batteries will continue to be increasingly in demand.

### SUMMARY

A battery housing for lithium ion cells includes a plurality of cell modules, having a plurality of cells between a top conductive plate and a bottom conductive plate and attached to the conductive plate by tabs attached to similarly polarized ends of each of the cells in the module to define a parallel connection between all of the cells in the module. A battery housing stacks the modules to define a series connection between the stacked charge plates, and electrically couples adjacent stacks with a common charge plate to define a series connection between each of the stacks. Charge logic for preventing excessive charging or discharging of the cells, and permits charge and discharge rates up to 6 C. Tabs on each conductive plate provide a redundant connection to each circular face of the cells for resisting shock and vibration. The housing further includes an ultrasonically welded top, and insulating plates screwed between each module for containing the modules in resilient engagement sufficient to pass scrutiny under standards such as UN 38.3 Lithium metal and lithium ion batteries.

An example configuration disclosed herein includes a 2*2 arrangement of modules, each module including 14 cylindrical cells in which each cell has circular faces of opposed polarity. Conductive plates welded to the circular faces of the cells allow each conductive plate to electrically couple circular faces of like polarity, as each cell in the module is disposed in a parallel orientation between 2 opposed conductive plates for electrically coupling the cells in the module in parallel. Pinch welds between each stack of two modules electrically couple conductive plates of opposed polarity for defining a series connection between the modules, and a bottom, common conductive plate between two adjacent modules electrically couples each stack in series. The series connection between each module of 14 parallel cells yields a so-called 4s14p arrangement yielding 14.8 volts when the cells are 26650 cells with a nominal voltage of 3.7 v, and a discharged voltage of 2.5 v, and is intended for 12 v applications.

Configurations herein are based, in part, on the observation that lithium ion batteries enjoy substantial advantages over earlier battery chemistries such as Nickel cadmium (NiCad) and Nickel medal hydride (NiMH) cells. Lithium ion chemistry allows faster charge and discharge rates, as well as being lighter than their prior art counterparts.

Unfortunately, conventional approaches to lithium ion battery construction may not incorporate sufficient structural and electrical redundancy for rugged environments such as vehicles or high reliability industrial applications such as grid support and periodic generation (e.g. solar panels, windmills). Due to the high discharge rates available with Lithium ion (Li) chemistry, runaway currents and short circuits can damage electronics and even cause a fire.

Accordingly, configurations herein substantially overcome the shortcoming of conventional battery construction and assembly by providing safeguards against overcurrent discharge, overheating, and mechanical degradation. Redundant battery tabs and welded conductors avoid shock and vibration effects that can interrupt connections. Multiple welded connections between cells and cell modules provide electrical redundancy. Multiple fusible couplings at the cell, module, and pack level, as well as redundant thermal sensing, quickly stems overcurrent situations before heat generation rises to detrimental levels.

Configurations herein are directed toward compliance with the UN (United Nations) standard on the transport of dangerous goods pertaining to tests and criteria for lithium metal and lithium ion batteries, promulgated as UN 38.3 Lithium metal and lithium ion batteries. Industry standards such as UN 38.3 and CAN bus demand resiliency and protection against runaway charge to avoid hazardous conditions when lithium batteries are employed in mobile applications such as hybrid and electric vehicles and trailer mounted grid support.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a stored power environment suitable for use with configurations herein;

FIGS. 2a and 2b are isometric views of a battery housing and assembly as disclosed herein.

FIG. 3 is an exploded view of the battery assembly of FIG. 2;

FIG. 4 is a longitudinal side elevation of the battery assembly as disclosed herein;

FIG. 5 is an isometric view of the battery interior as disclosed herein;

FIG. 6 is a schematic diagram of the battery assembly of FIG. 2;

FIG. 7 is a top diagram of the battery assembly of FIG. 2

FIGS. 8a-8c are a diagram of a charge plate in the battery assembly of FIG. 2;

### DETAILED DESCRIPTION

Depicted below are configurations of a battery enclosure and battery cell (cell) arrangement for a lithium ion battery. Due to the potentially high discharge rates available with lithium ion cells, the enclosure exhibits structural and electrical robustness and redundancy to guard against accidental discharge, or so-called “runaway” currents. Since power based cells are relied upon for high discharge rates, in contrast to counterparts in portable, personal devices which emphasize longevity, it is important to ensure that the architecture and design of the enclosure and the cells therein anticipates the working environment of such batteries, particularly since usage often involves vehicular transport and other context where physical shock and vibration tend to occur. Further, several industry standards, most notably UN 38.3 and CAN bus are relied upon as exemplary criteria.

Configurations herein depict a battery enclosure having a plurality of multi-cell modules connected in series, in which each module has a number of cells in parallel. In a particular example configuration shown, the battery enclosure (battery) has 4 modules, each with 14 cells, and may be referred to as a 4s14p enclosure. The modules are connected in series to an adjacent module or to a bussbar leading to one of the terminals of the battery. All 14 cells in the module are oriented similarly to connect in parallel to conductive plates at each end of the cells. One of the conductive plates is positive (+), and the opposed plate is negative (−), based on which end of the similarly positioned cells the conductive plate is attached.

The example arrangement anticipates 26650 lithium ion cells, aptly named for cylindrical shaped cells having a diameter of 26 mm and a length of 650 mm. Each cell has opposed voltages at each circular end, thus has a (+) side and a (−) side, as cell orientation will be referred to below. A nominal voltage of 3.7 v yields a battery pack of 14.8 volts when four modules connect in series.

The 4s14p mechanical assembly is broken up into two modules. The “top” module holds 28 26650 cells. The bottom module holds another 28 26650 cells also, for a total of 56 cells per 4s14p unit. The configuration is 4 cell groups (modules) in series with 14 cells in each group in parallel. Each module has two Fire Retardant ABS plastic end caps that hold the cells in place. The two end caps per module may be assembled with thread forming plastite screws.

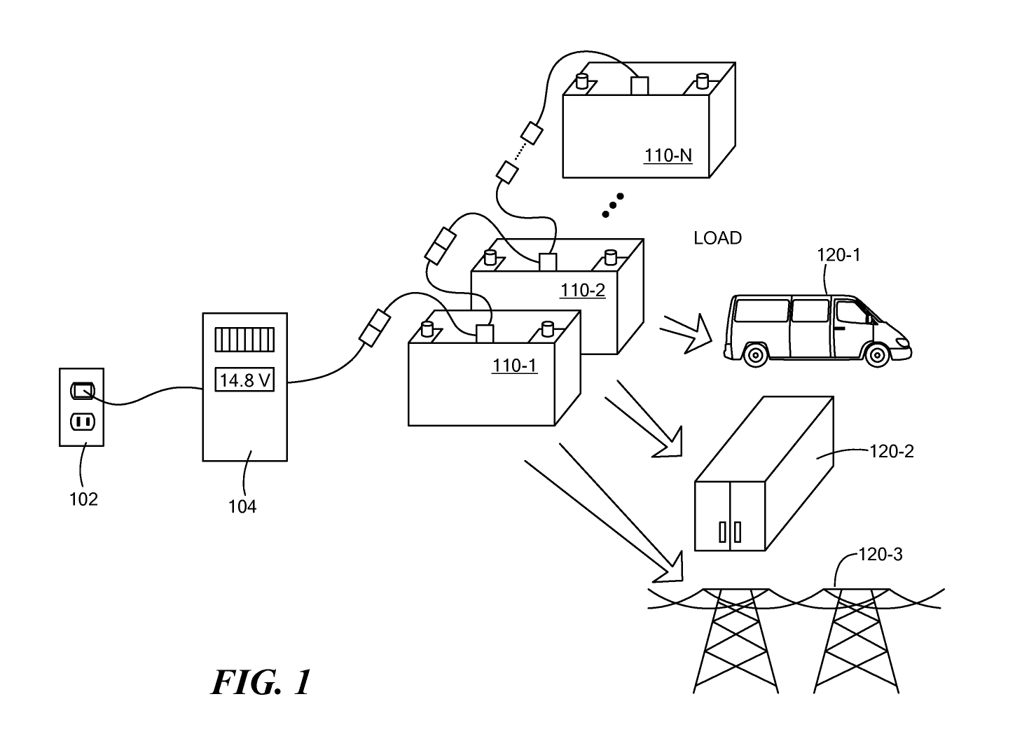

FIG. 1 is a context diagram of a stored power environment suitable for use with configurations herein. Referring to FIG. 1, lithium-ion batteries operate in applications where longevity, high discharge rates and fast recharge acceptance are important. In an environment 100 where stored power is invoked or used, lithium ion batteries 110-1 . . . 110-N (110 generally) are deployed where loads 120-1 . . . 120-3 (120 generally) require high current discharge. For example, a lithium ion battery 110 or bank of such batteries 110-N is often employed for hybrid and electric vehicles 110-1, industrial power storage and support 110-2, and power grid applications 110-3. The batteries 110 are then rapidly recharged from an available power source 102 using a charge controller 104, and the charge/discharge cycle iterates for many usages.

As lithium ion batteries have the capacity for high current discharge, resilience in design to avoid accidental sudden discharge that could result in high temperatures or fires is paramount. Further, for high current and industrial applications, where substantial voltages and currents are employed, there is also an increased risk of impact and shock related incidents as banks of batteries undergo vehicular transport for hybrid automobiles and trailer-based deployment.

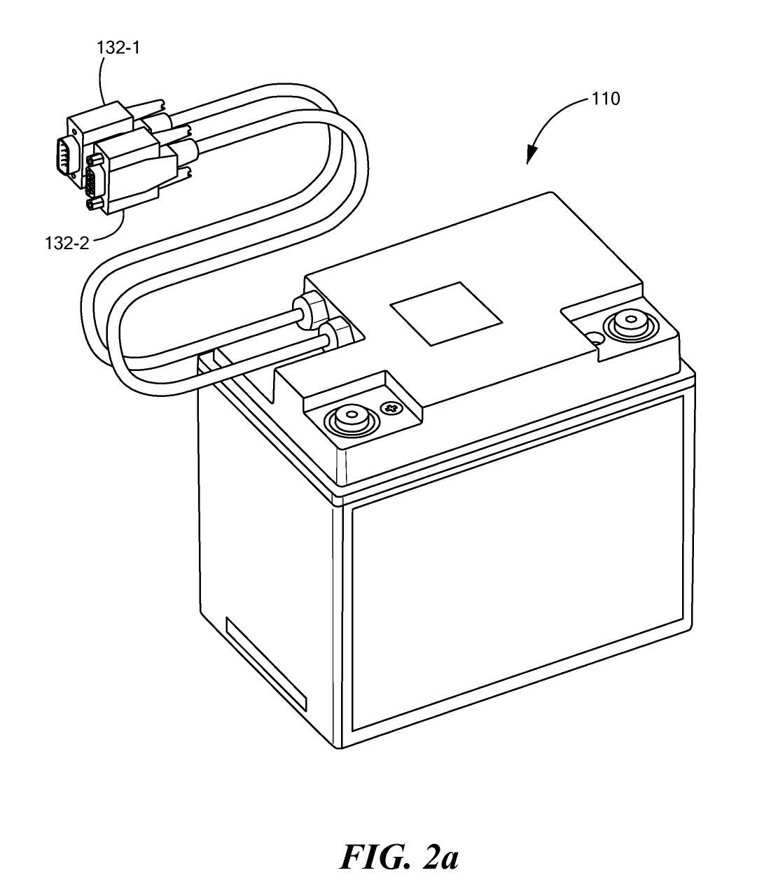

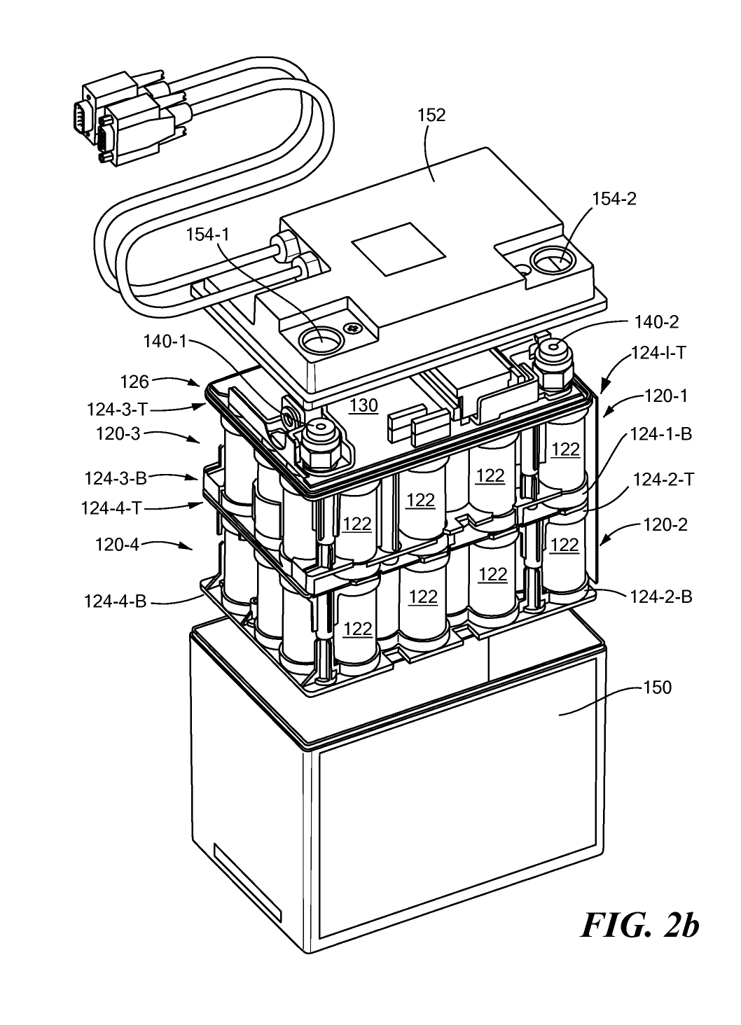

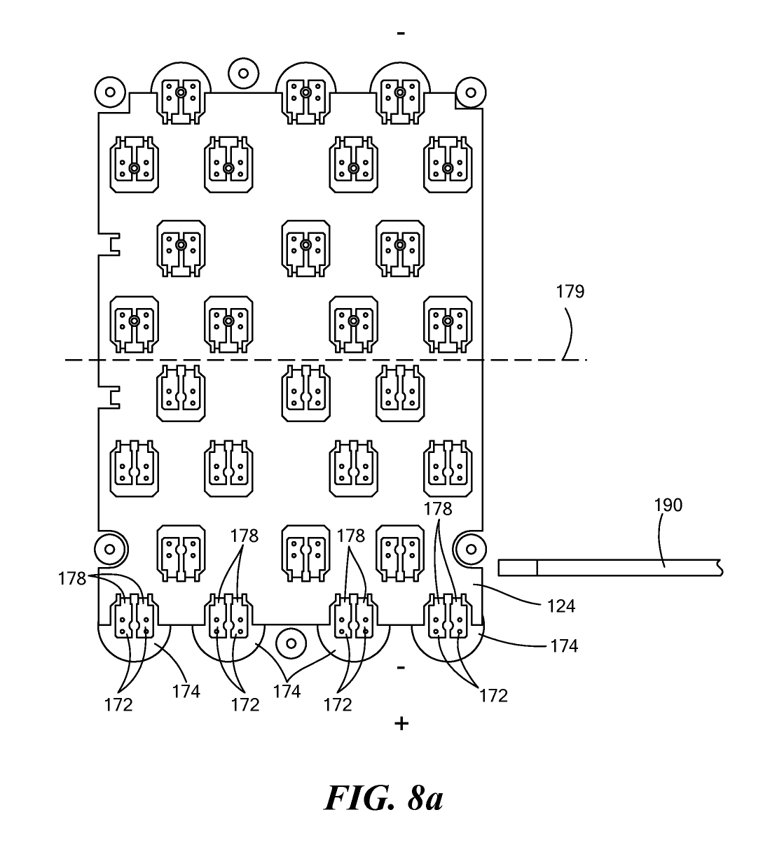

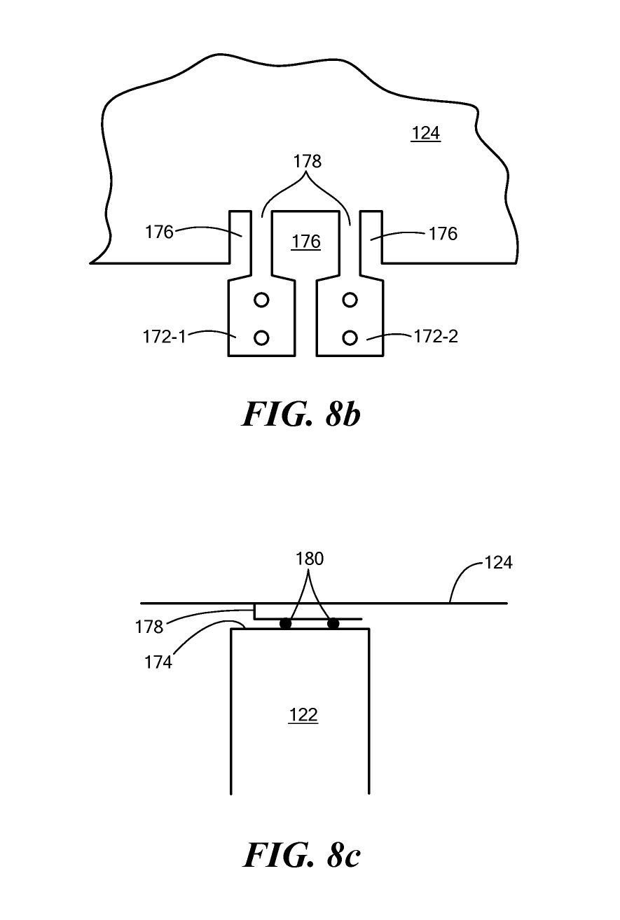

FIGS. 2a and 2b are isometric views of a battery housing and assembly as disclosed herein. Referring to FIGS. 2a and 2b, the battery enclosure as disclosed herein includes a plurality of cell modules 120-1 . . . 120-4 (120 generally), such that each cell module 120 has a plurality of cells 122 between a top conductive plate 124-1 . . . 4-T and a bottom conductive plate 124-1 . . . 4-B, such that each conductive plate has tabs attached to similarly polarized ends of each of the plurality of cells in the module, shown further below in FIG. 8. A controller layer 126 includes charge logic 130 for preventing excessive charging or discharging of the cells 122. Each of the plurality of cell modules 120 has a series connection to an adjacent cell module, and cells 122 in each module 120 share a parallel connection to the conductive plates, as the cells 122 in each module 120 are oriented so that the polarity at each end is similar (i.e. all positive or all negative), thus imparting a common voltage to each of the top and bottom charge plates.

The controller layer allows charging and discharging up to co-called “6 c” rates, allowing approximately a 6*current draw over the amp hour rating on the cells. Charging also enjoys similar enhanced rates.

A pair of terminals 140-1, 140-2 (140 generally) are configured for external connection to the serially interconnected modules 120. In particular configurations, control interfaces 132-1, 132-2 allow daisy chaining across a plurality of batteries 110 for monitoring and controlling charging and discharging. An enclosure 150 and ultrasonically welded top 152 encapsulate the modules and control circuitry, and have portals for the terminals 140 and control interfaces. In the example configuration, the brass terminals 140 are round at the top, with a threaded hole for battery lug connections. The terminals also have a hex shape that matches up with the fire retardant ABS cover. The hex shape in the cover along with the epoxy provides the strength to secure the terminal in place and protect the PCB from being stressed for up to 160 in-lbs of torque on terminal.

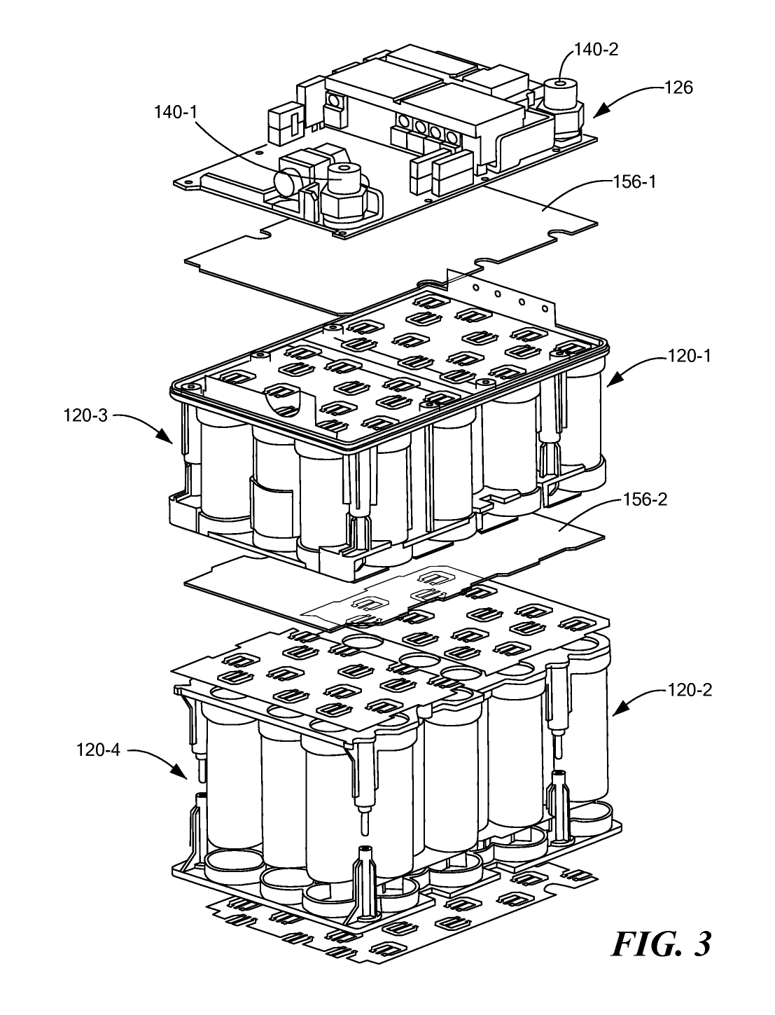

FIG. 3 is an exploded view of the battery assembly of FIG. 2. Referring to FIGS. 2 and 3, the enclosure 150 contains the plurality of modules 120. The top 152 further includes a terminal receptacle 154-1 . . . 154-2 (154 generally), each adapted to receive a corresponding terminal 140 and has a non-circular shape for engaging a corresponding shape on the terminal, such as a hex or square. Such engagement prevents rotation and over-torqueing of wires or logs attached to the terminals, as the top 152 absorbs rotational force on the terminals, rather than the underlying control layer 126 (e.g. circuit board). The terminal 140 may also be chemically affixed in the terminal receptacle 154 for resisting rotational torque applied to the terminal, such as by an epoxy or similar adhesive.

Each conductive surface of the conductive plates 124 includes an insulating plate 156-1 . . . 156-2 between the adjacent, or stacked, modules 120, such that the insulating plate has at least one post having a concave shape, the concave shape for engaging a convex protrusion on the conductive plate. To maintain alignment of the insulating plate with the corresponding conductive plate, the concave and convex shapes engage frictionally compressively. In an example configuration, the concave shape may be a cross (+) and the convex shape being a similar cutout on the conductive plate such that the convex “points” of the cross cutout engage the protruding (+) in a barb-like manner.

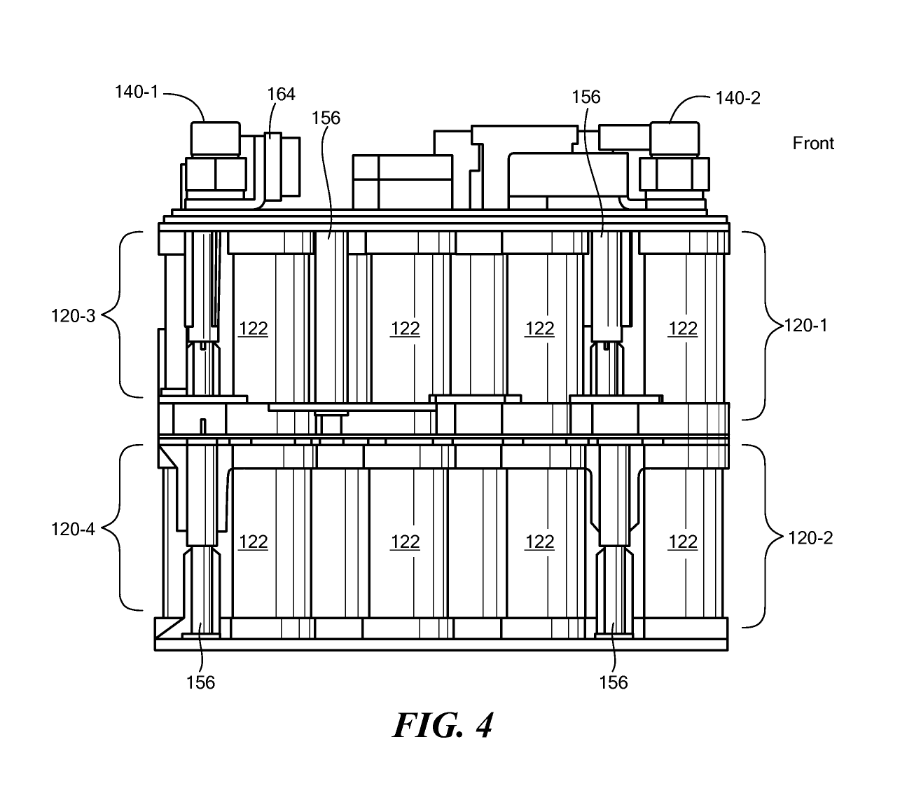

FIG. 4 is a longitudinal side elevation of the battery assembly as disclosed herein. Referring to FIGS. 2-4, the longitudinal elevation shows four cells 122 on each of two levels in a stacked arrangement. Each module 120 includes two of the cell shown, as the cells 122 in each module 120 occupy 4 rows of 3-4-3-4 cells to complete the 14 cells in each module. Screw posts 156 join the layers of cells, and are interspersed between the cells 122 in a noninterfering manner.

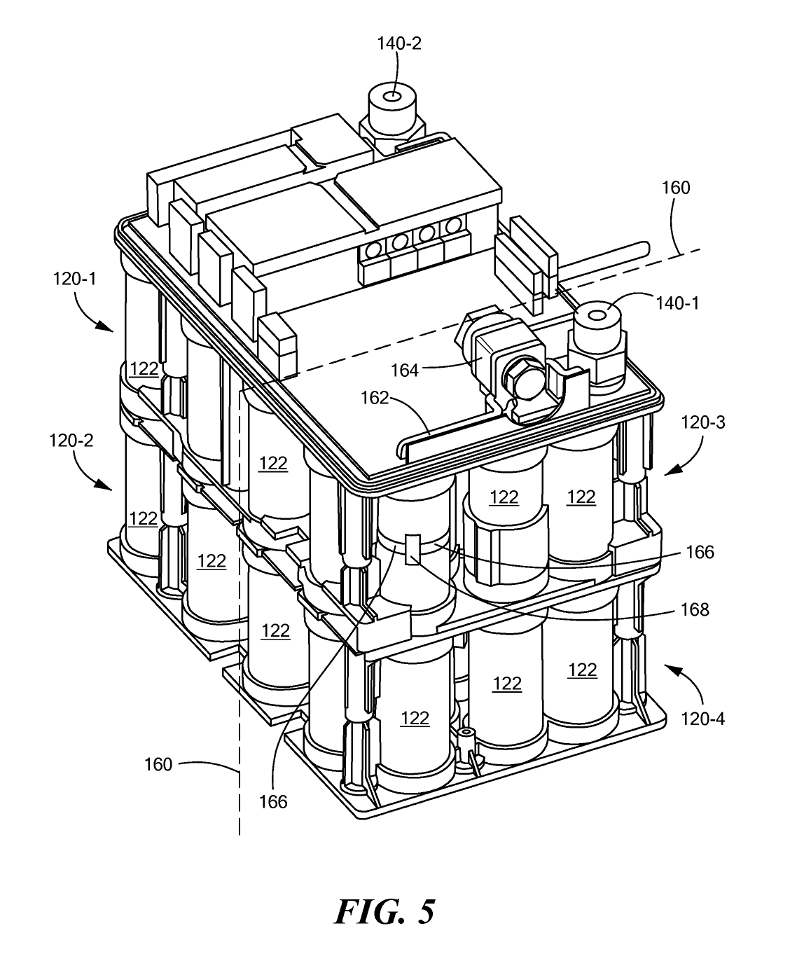

FIG. 5 is an isometric view of the battery interior as disclosed herein. Referring to FIGS. 2-5, the cells 122 are visible in the respective modules 120 as the two columns defined by modules 120-1, 120-2 and 120-3, 120-4 are separated by dotted line 160. Also visible are a bussbar 162 providing electrical continuity to the terminal 140-1, and a master fuse 164 between the bussbar 162 and the terminal 140-1. A temperature sensitive circuit element 166 such as a thermistor engages at least one of the cells 122, such that the temperature sensitive circuit element 166 is biased against an exterior of the cell by a resilient member 168 engaging an outer circumference of the cell 122. In the example shown, a circular clip has two prongs that extend greater than halfway around the cell 122 for drawing the circuit element into communication with the cell for detecting excessive temperature. Compressive biasing by the clip is superior to chemical adhesives which can leave a layer of glue or adhesive, and separate the circuit element 166 off the surface of the cell 122.

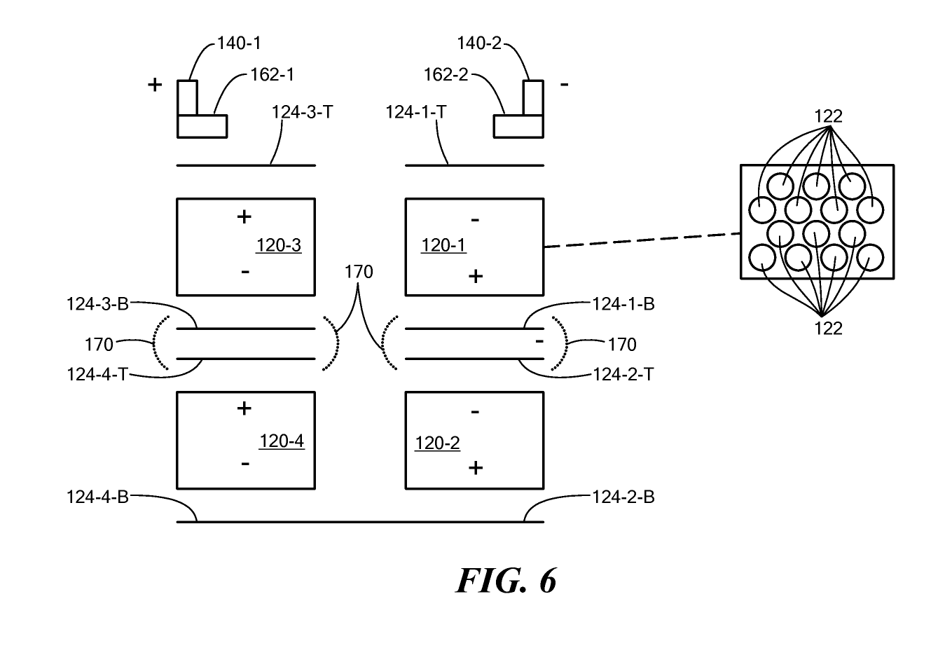

FIG. 6 is a schematic diagram of the battery assembly of FIG. 2. Referring to FIG. 206, each of the plurality of cell modules 120 is connected in series to an adjacent cell module 120. In the example shown, using 26650 lithium calls, each cell has a cylindrical shape and opposed ends of opposite polarity, and each cell is welded at each opposed end to the conductive plate 124 common to each end of the cells in the module 120 of similar polarity. In other words, all the cells 122 align the same way so that all positive terminals contact the conductive plate on one side of the module and all negative terminals contact the conductive plate on the opposed side of the module, thus forming a layered structure with the cells “sandwiched” between conductive plates. Since all cells are oriented the same way, all contact the respective conductive plates in parallel to provide a 3.7 v potential between the conductive plates 124 on the top and bottom.

Each module 120-1 . . . 120-4 has a top and bottom conductive plate 124-1-T/B . . . 124-4-T/B for top and bottom, respectively. Each conductive plate defines a parallel connection for each of the cells 122 in the module 120, and therefore each module 120 has a positive (+) and negative (−) conductive plate with an adjacent module 120. The conductive plates are electrically coupled to a conductive plate of an adjacent module, in which the coupled conductive plates having an opposed polarity. The modules 124 therefore form a series connection to the adjacent module by coupling to a conductive plate of an opposed polarity, and to a bussbar 162-1 . . . 162-2 at respective ends of the series (modules 120-1 to the negative bussbar 162-2 and module 120-4 to the positive bussbar, in the example shown.

The modules 120 couple either vertically or horizontally to adjacent modules 120, thus forming a series of adjacent “stacked” modules. The example configuration shows two stacks of two modules, to form a series of 4 modules, but alternate arrangements may be invoked. In the vertical coupling, as between modules 120-1 to 120-2 and modules 120-3 to 120-4, the electrical coupling includes pinch welding 170 to an adjacent module to join the conductive plates 124. In the stack, the top and bottom modules are screwed together with thread forming plastite screws. The two modules are then “pinch” welded at 4 locations per side to make the module to module electrical connection. An insulator 156 is assembled between the two modules to isolate the connections and improve the voltage sense. Each weld strap has a faston connection that provides a voltage sense point connection with a wire that travels back to the PCB.

In the horizontal coupling, as between modules 120-2 and 120-4, a continuous conductive plate spans multiple adjacent modules, shown as 124-2-B and 124-4-B. Alternatively, separate conductive plates 124 could be joined by welding, rather than providing a continuous plate spanning two modules. The resulting arrangement includes a plurality of modules 120 stacked in a longitudinal direction of the cylindrical cells 122 (i.e. stacked in the direction of the longer, cylindrical side of the cells) and electrically coupled to an adjacent stack of modules 120 sharing a common conductive plate, such that the common conductive plate forms a series connection between module 124-2-B and an opposed polarity of module 124-2-B of the plurality of modules.

In the example arrangement, following assembly of the modules by welding or other suitable coupling, the system is now a “pack” and is placed in the plastic housing 150 thread forming plastite screws securing the bottom end cap to the bottom of the case. The top cover is placed on top of the case so that the brass terminals are centered on the cover holes. The cover has a groove designed around the perimeter which mates with a rib at the top of the case. The rib on the case has an interference with a “shear” design for ultrasonic welding. The entire assembly is then placed into a fixture and the top cover is ultrasonically welded to the case. The gap around the terminals is then sealed with epoxy to join the hex shaped terminals to a corresponding receptacle on the cover for torque resistance. The epoxy fills the gap around the terminal, provides strength, and helps to seal out water and dust in order to meet IP54 rating.

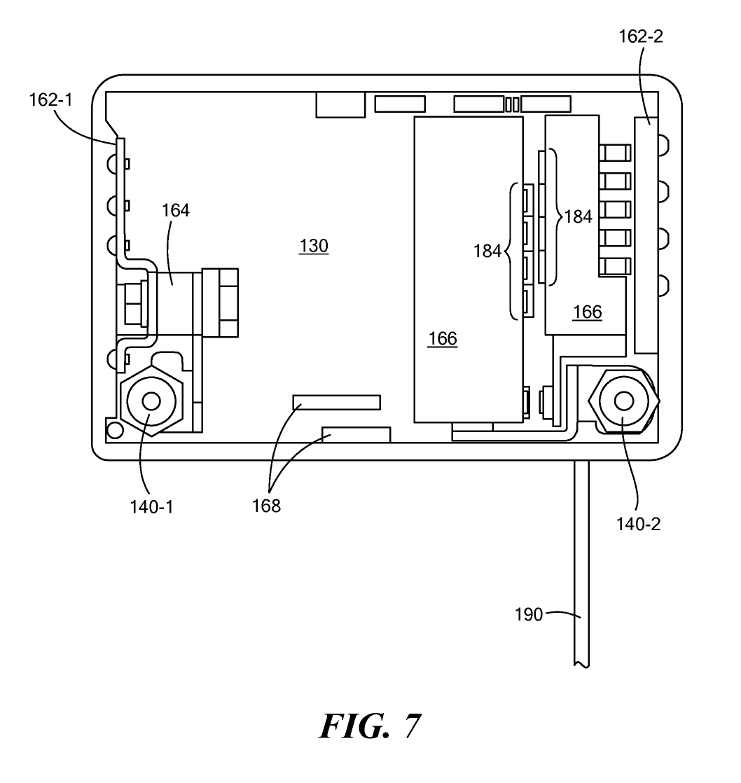

FIG. 7 is a top diagram of the battery assembly of FIG. 2. Referring to FIGS. 2 and 7, the top of the battery includes bus bars 162, terminals 140, a circuit board 130 having charge logic, a main output fuse 164 or fusible link, heat sinks 166 and connectors 168 for the control interfaces 132. The circuit board 130 therefore defines a PCB assembled onto the top end cap on the top module with plastite screws. The top module has an insulator on it to isolate the PCB from the top module weld straps. The PCB is connected to the pack by screws that secure the top negative weld strap to the Negative bus bar on the PCB. The positive weld strap is connected to the Positive bus bar on the PCB also by screws. An example pinch weld electrode 190 approximates the position of the pinch welds of the conductive plates 124.

A plurality of FETs (Field-Effect Transistors) 184 are responsive to the control interfaces 132 for switching charge and discharge current, and hence, the charge/discharge rate. A sufficient number of FETs allows a 6 c discharge rate of up to 210 amps for 35 Ah (Amp hour) cells.

FIGS. 8a-8c are a diagram of the conductive plate 124 in the battery assembly of FIG. 2. FIG. 8a shows an example conductive plate 124 depicting the multiple module conductive plate 124-2-B and 124-4-B. A single module conductvie plate would bisect along dotted line 179. The conductive plate has a plurality of tabs 172 for connection to each cell 122. The example configuration employs two for each end (pole) on each cell, spot welded to the curcular surface on the cell 174. FIG. 8b shows a plan view of a tab connection to a single cell 122, and FIG. 8c shows a side elevation of the tab 172 connection. The conductive tabs 172 are defined by a cutout 176 in the conductive plate 124, thus an array of cutouts 176 in the continuous conductive plate provides for attachment to opposed ends of each of the cells 120.

A leg 178 in the cutout is a narrower portion that is deformed toward the cell end 174. The legs 178 are deformed to dispose the tabs out of plane with the conductive plate for biasing against an end 174 of the cells 122. The tabs 172 are affixed by spot welds 180. Two spot welds 180 on each tab 172 avoid rotation of the tab 172 on the cell end 174 resulting from a single weld. Additional welds may be employed depending on an area of the tab 172. The tabs 172 and legs 178 are adapted to maintain electrical connectivity and withstand shock and vibration according to a predetermined standard, such as UN 38.3.

The cutouts 176 facilitate welding of the tabs by directing a welding current to the other of the pair of tabs rather than shorting the weld circuit. Each conductive plate 124 has a plurality of tabs are welded to each end of the cells, in which a welding circuit including at least two of the tabs and a distance of the leg is sufficiently long to avoid shorting the welding circuit between the pair of tabs. In other words, a surface distance between the tabs 172-1 and 172-2 is sufficient that a welding current applying opposed polarity to each tab 172-1, 172-2 will not travel across the leg to the opposed polarity and effectively short the current flow providing the weld arc. Therefore, each cell end 174 couples to a pair of tabs 172-1, 172-2 spot welded to each of the opposed ends of each of the cells 120, such that each tab 172 of the pair of tabs receives opposed electrodes of the same welding circuit, in which the cutout 176 and legs 178 defining each pair is sufficiently large to disrupt an electrical path between the opposed electrodes. Rather, a welding current path travels across the ends 174 of the cell 122 to the tab 172 corresponding to the opposed electrode of the weld circuit. In other words, the electrical “distance” between the weld electrodes is shortest across the ends 174 of the cell 122, rather than around the cutout 176 via the legs, directing the weld current to arc at the tab 172 as it contacts the cell 122 end 174. The tabs 172 may have dimples to define the weld 180 points,

Each of the legs connected to at least one of the ends of each cell has a width and thickness based on a maximum allowable current flow, in which the legs configured such that current flow exceeding the maximum disrupts a connection through the leg by melting the leg material. Therefore, the leg may act as a fuse for limiting a runaway or excessife discharge by melting and interrupting the circuit. In an example arrangement, the fusable legs connect to one side (polarity), although could be applied to all legs. The plurality of tabs also provides redundancy for shock and vibration resistance. In the example arrangement, the negative weld tabs are designed as a fuse in case of a runaway cell condition.

While the methods and apparatus defined herein have been particularly shown and described with references to embodiments thereof, it will be understood by those skilled in the art that various changes in form and details may be made therein without departing from the scope of the invention encompassed by the appended claims.

What is claimed is:

1. A battery device, comprising:
a plurality of cell modules, each cell module having a plurality of cells between a top conductive plate and a bottom conductive plate, each conductive plate having tabs attached to similarly polarized ends of each of the plurality of cells in the module;
charge logic for preventing excessive charging or discharging of the cells;
each of the plurality of cell modules having a series connection to an adjacent cell module, the cells in each module sharing a parallel connection to the conductive plates; and
terminals configured for external connection to the serially interconnected modules.

2. The device of claim 2 wherein each of the plurality of cell modules is connected in series to an adjacent cell module, each cell having a cylindrical shape and opposed ends of opposite polarity, the cell welded at each opposed end to the conductive plate common to each end of the cells in the module of similar polarity.

3. The device of claim 2 wherein the conductive plates are electrically coupled to a conductive plate of an adjacent module, the coupled conductive plates having an opposed polarity.

4. The device of claim 3 wherein the electrical coupling includes at least one of pinch welding to an adjacent module or a continuous conductive plate spanning multiple adjacent modules.

5. The device of claim 2 further comprising a plurality of modules stacked in a longitudinal direction of the cylindrical cells electrically coupled to an adjacent stack of modules sharing a common conductive plate, the common conductive plate forming a series connection between a first module and an opposed polarity of a second module of the plurality of modules.

6. The device of claim 1 wherein the tabs further comprise:
a cutout forming a tab in a continuous conductive plate for attachment to opposed ends of each of the cells; and
legs between the cutout tab and the conductive plate, the legs deformed to dispose the tabs out of plane with the conductive plate for biasing against an end of the cell;
the tabs and legs adapted to maintain electrical connectivity and withstand shock and vibration according to a predetermined standard.

7. The device of claim 6 wherein a plurality of tabs are welded to each end of the cells, a welding circuit including at least two of the tabs and a distance of the leg is sufficiently long to avoid shorting the welding circuit between the pair of tabs.

8. The device of claim 6 further comprising a pair of tabs spot welded to each of the opposed ends of each of the cells, such that each tab of the pair of tabs is configured to engage opposed electrodes of the same welding circuit, the cutout and legs defining each pair sufficiently large to disrupt an electrical path between the opposed electrodes, a welding current path traveling across the ends of the cell to the tab corresponding to the opposed electrode.

9. The device of claim 5 further comprising an enclosure, the enclosure containing the plurality of modules, further including:
a terminal receptacle, each terminal receptacle adapted to receive a corresponding terminal and having a non-circular shape for engaging a corresponding shape on the terminal, the terminal chemically affixed in the terminal receptacle for resisting rotational torque applied to the terminal.

10. The device of claim 9 further comprising a temperature sensitive circuit element engaging at least one of the cells, the temperature sensitive circuit element biased against an exterior of the cell by a resilient member engaging an outer circumference of the cell.

11. The device of claim 5 further comprising an insulating plate between the adjacent modules, the insulating plate having at least one post having a concave shape, the concave shape for engaging a convex protrusion on the conductive plate.

12. The device of claim 6 wherein the legs connected to at least one of the ends of each cell has a width and thickness based on a maximum allowable current flow, the legs configured such that current flow exceeding the maximum disrupts a connection through the leg by melting the leg material.

13. A method of forming an enclosure for lithium, ion cells, comprising:
welding each circular side of a plurality of cylindrical cells to a conductive plate, each conductive plate having tabs attached to similarly polarized ends of each of the plurality of cells, the welded cells defining a cell module, the welded conductive plates defining a parallel connection of the cells in the cell module;
connecting a plurality of modules in series to an adjacent cell module;
coupling charge logic to each of the cell modules, the charge logic configured to regulate charge and discharge rates; and
connecting a bussbar and terminal to respective ends of the serially connected cell modules for providing an aggregate voltage of the cell modules.

14. The method of claim 13 further comprising pinch welding the conductive plates of adjacent modules, the conductive plates are electrically coupled to a conductive plate of an adjacent module, the coupled conductive plates having an opposed polarity.

15. The method of claim 14 further comprising electrical coupling the adjacent cell modules by at least one of pinch welding to an adjacent module or a providing continuous conductive plate spanning multiple adjacent modules.

16. The method of claim 15 further comprising stacking a plurality of modules in a longitudinal direction of the cylindrical cells for electrically coupling to an adjacent stack of modules sharing a common conductive plate, the common conductive plate forming a series connection between a first module and an opposed polarity of a second module of the plurality of modules.

17. The method of claim 13 further comprising
forming a cutout in a continuous conductive plate for defining tabs for attachment to opposed ends of each of the cells, the cutout forming legs between the cutout tab and the conductive plate, the legs deformed to dispose the tabs out of plane with the conductive plate for biasing against an end of the cell;
the tabs and legs adapted to maintain electrical connectivity and withstand shock and vibration according to a predetermined standard, the legs being fusible for preventing an overcurrent condition.

18. The method of claim 17 further comprising welding a plurality of tabs to each end of the cells, welding including applying weld electrodes of opposed polarity to at least two of the tabs for defining a weld circuit across the circular side, a distance of the leg being sufficiently long to avoid shorting the welding circuit between the pair of tabs.

19. A rechargeable battery, comprising:
a 2*2 arrangement of modules, each module including 14 cylindrical cells; each cell having circular faces of opposed polarity;
conductive plates welded to the circular faces of the cells, each conductive plate electrically coupling circular faces of like polarity, each cell in the module disposed in a parallel orientation between 2 opposed conductive plates for electrically coupling the cells in the module in parallel;
pinch welds between a stack of two modules for electrically coupling conductive plates of opposed polarity for defining a series connection between the modules;
a common conductive plate between two adjacent modules for electrically coupling each stack in series;
the pinch welds and common conductive plate defining a series connection for aggregating the voltage from each of the serially connected modules;
a bussbar and terminals connected to each end of the serially connected modules; and
charge logic for switching charge and discharge currents between the cells and terminals;
a pair of tabs defined by cutouts in the conductive plate welded to each circular face of the cells, the cutout defining a deformable leg for disposing the tabs out of plane with the circular plate, the cutout defining an electrical distance longer than an electrical path between opposed welding electrodes along the circular face for directing a welding current across the circular face between the pair of tabs.

20. The battery of claim 19 wherein the charge logic is coupled to a control interface, the control interface configured to direct switching of charge and discharge current across an interconnected plurality of batteries, wherein each of the tabs welded to at least one circular face of each cell defines a fusible link based on a maximum discharge rate.
